(19) United States
(12) Patent Application Publication
(10) Pub. No.: US 2018/0129579 A1
(43) Pub. Date: May 10, 2018

(54) Systems and Methods with a Realtime Log Analysis Framework

(71) Applicant: NEC Laboratories America, Inc., Princeton, NJ (US)

(72) Inventors: Biplob Debnath, Princeton, NJ (US); Nipun Arora, Plainsboro, NJ (US); Hui Zhang, Princeton Junction, NJ (US); Guofei Jiang, Princeton, NJ (US); Mohiuddin Solaimani, Dallas, TX (US); Muhammad Ali Gulzar, Los Angeles, CA (US)

(21) Appl. No.: 15/784,393

(22) Filed: Oct. 16, 2017

Related U.S. Application Data
(60) Provisional application No. 62/420,034, filed on Nov. 10, 2016.

(51) Int. Cl. G06F 11/34; G06F 11/07; G06F 11/30; G06F 15/18

(52) U.S. Cl. CPC G06F 11/3476; G06F 15/18; G06F 11/3065; G06F 11/0706

(57) ABSTRACT

Systems and methods are disclosed for processing a stream of logged data by: creating one or more models from a set of training logs during a training phase; receiving testing data in real-time and generating anomalies using the models created during the training phase; updating the one or more models during real-time processing of a live stream of logs; and detecting a log anomaly from the live stream of logs.

This application claims priority to Provisional Application Ser. No. 62/420,034 filed Nov. 10, 2016, the content of which is incorporated by reference.

### BACKGROUND

Modern technologies such as IoT, Big Data, Cloud, data center consolidation, among others, demand smarter IT infrastructure and operations. These systems continuously generate voluminous logs to report their operational activities. Efficient operation and maintenance of the infrastructure require many of the least glamorous applications, such as troubleshooting, debugging, monitoring, security breaching in real-time. A log is a semi-structured record which carries operational information. Complex systems like, nuclear power plant, data center, etc., emit logs daily. Logs come periodically with high volume and extreme velocity. Although logs are scattered but they spot system's operational status, and thus logs are very useful to the administrators to capture snapshot of a system's running behaviors.

Logs spot the fundamental information for system administrators and are useful to diagnose the root cause of a complex problem. Log analysis is the process of monitoring and extracting valuable information from logs to resolve a problem. It has variety of usages in security or audit compliance, forensics, system operation and management, or system troubleshooting. Analyzing high volume logs in real-time is daunting task for system administrators, and so they require a scalable automated log analysis solution. Because of the high volumes, velocities, and varieties of log data, it is an overwhelming task for humans to analyze these logs without a real-time scalable log analysis solution.

### SUMMARY

In one aspect, systems and methods are disclosed for processing a stream of logged data by: creating one or more models from a set of training logs during a training phase; receiving testing data in real-time and generating anomalies using the models created during the training phase; updating the one or more models during real-time processing of a live stream of logs; and detecting a log anomaly from the live stream of logs.

In another aspect, a log analysis framework collects continuous logs from multiple sources and performs log analysis using its models which are built before. Log analysis has two parts: learning/training and testing. It builds training model from normal logs and performs anomaly detection in real-time. Multiple anomaly detectors find unusual behavior of the system by identifying anomaly in logs. Log analysis can be stateful or stateless. Stateful analysis stores temporal data flow/transaction is kept in memory or state, e.g., database transnational log sequence. Stateless analysis doesn't require this, e.g., filtering Error logs.

Implementations may include one or more of the following. The system provides an end-to-end framework for heterogeneous log analytics: It provides reference architecture for streaming log analytics with a clear workflow for “stateful”, “stateless” and “time-series” log analysis. The framework provides a dynamic log model management component—this allows dynamically updating changing and deleting log models in data streaming frameworks not done by existing systems.

Advantages of the system may include one or more of the following. The log analysis tools and solutions are easy to use due to automation to ease human burden. In particular the system provides an easy to use workflow to develop log analytics tools. In one embodiment called LogLens, a streaming log analytics application provides reference architecture and workflows for analyzing logs in real-time. The system is a comprehensive service oriented architecture as well as a dynamic model update mechanism for streaming infrastructures. The system provides unsupervised learning: The automated log analyzer works from scratch without any prior knowledge or human supervision. For logs from new sources, it does not require any inputs from the administrator. The system provides heterogeneity: Logs can be generated from different applications and systems. Each system may generate logs in multiple formats. The log analyzer can handle any log formats irrespective of their origins. The system is deployable as a service as logs volume and velocity could be very high. It is scalable, and operates without any service disruption to handle drift in the log data behaviors.

### BRIEF DESCRIPTION OF THE DRAWINGS

FIG. 1 shows an exemplary log analysis framework

FIG. 2 shows an exemplary training phase, while FIG. 3 shows an exemplary conversion of a log to a regular expression.

FIG. 4 shows three exemplary models generated by the framework of FIG. 1.

FIG. 5 shows an exemplary Testing Phase module.

FIG. 6 is an illustrative block diagram of the Model Manager.

FIG. 7 shows an exemplary Dynamic Model Update in Streaming Systems.

FIG. 8 shows in more detail the log analyzer architecture.

FIG. 9 shows an exemplary stateful algorithm implementation in a MapReduce based Streaming System.

FIG. 10 shows periodic HeartBeat Message propagation.

FIG. 11 shows internal operation in MapWithState.

### DESCRIPTION

FIG. 1 shows an exemplary log analysis framework called LogLens. LogLens reduces manual effort of mining anomalies from incoming logs for system administrators by highlighting potential anomalies in real-time. The system can find use for any device which generates logs; this includes IOT, software systems, point of sale systems etc. The system automates log mining and management process for administrators.

LogLens collects continuous logs from multiple sources and performs log analysis using its models which are built before. Log analysis has two parts: learning/training and testing. It builds training model from normal logs and performs anomaly detection in real-time. Multiple anomaly detectors in LogLens find unusual behavior of the system by identifying anomaly in logs. Log analysis can be stateful or stateless. Stateful analysis stores temporal data flow/transaction is kept in memory or state, e.g., database transnational log sequence. Stateless analysis doesn't require this, e.g., filtering Error logs.

The LogLens architecture is divided into several components. At a high level, first models are created from a set of training logs, and saved into the database. One implementation uses spark streaming for the instant testing phase, which receives testing data in real-time and generates anomalies using the models generated during the training phase. A model manager with dynamic model update functionality allows models to be updated during real-time processing of data in the instant streaming analytics. The system has the following modules:

Service Layer 1: The service layer is a “restful” API service which provides a mechanism for users to send and receive service layer requests for new data Sources. Transactions from the service request can be either for the training dataset in order to create training data models, or for the testing dataset to generate anomalies from the testing data.

Training Engine 2: The training engine takes input training logs and generates models, which are passed to the model manager 4. Training requests from the Service layer are forwarded to the training engine, along with parameters to support training the models.

Testing Module 3: This component takes a streaming input of logs, and transforms these logs into tokenized key, value pairs based on patterns/regular-expressions from log parsing model generated in the training phase. This tokenized log is then taken as an input to generate anomalies based on training models.

Model Manager 4: The model manager is the instant model management component that gets new models from the training component, manages model load into Spark Testing, and dynamically either updating the models or deleting previous models from existing broadcast variables.

Anomaly Database 5: The anomaly database stores all the anomalies which are reported to the end-user in real-time. All anomalies are reported to the anomaly database. It also responds to all user interfaces with the anomalies requested.

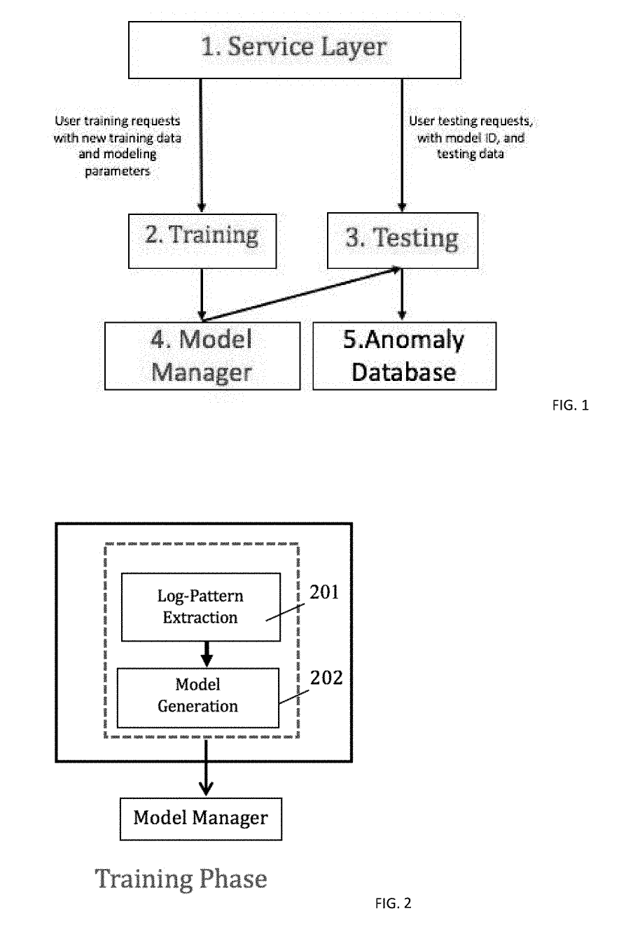

FIG. 2 shows an exemplary training phase, while FIG. 3 shows an exemplary conversion of a log to a regular expression. The training phase is made of the following two stages: Log Pattern Extraction (201) and Model Generation (202). In one embodiment, the pattern extraction stage 201 generates a regular expression for the incoming logs using unsupervised learning. Log patterns have variable fields with a wildcard pattern where each field has a keyname. The keynames can be attributed to well-known patterns, as well as unknown fields with generic names. For instance,
a. Named Fields: timestamp, Log ID, IP Address
b. Unknown: PatternlStringl, PatternlNumberl etc.

For instance the sample log shown FIG. 3 is converted to a regular expression. Here exemplary variables are, for instance:
ts1>TimeStamp of the log
P3F1->Pattern 3 Field 1
P3NS1->Pattern 3 AlphaNumericField 1

Turning to the model generation (202), the framework includes a platform for extracting a variety of profiles/models, which are aggregated together in a global model database. These models can be used later by anomaly detection service components to find relevant anomalies and alert the user.

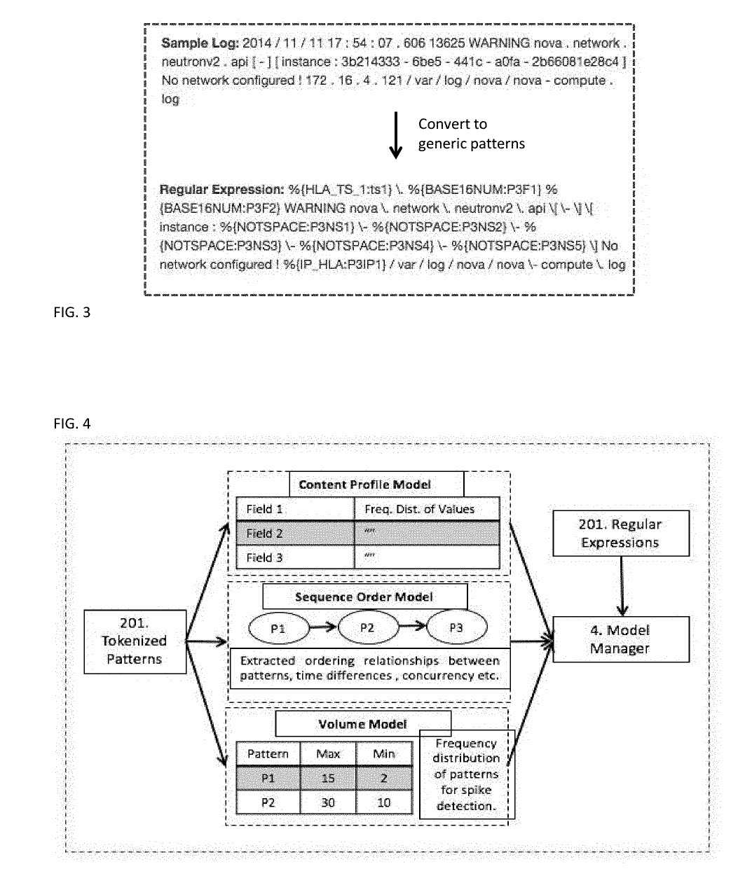

FIG. 4 shows three possible models that can be generated. These three models simply serve as an example of possible models that can be generated, however the architecture is not limited to them, and is meant to act as a service component for further such models.

a. Content Profile Model: This model looks creates a frequency profile of the various values for each key in the pattern/regular expression of a category of logs.

b. Sequence Order Model: This model extracts sequential ordering relationships between various patterns. For instance an observed transaction could be defined as Pattern 1 (P1) could be followed by Pattern 2 (P2), with a maximum time difference of 10 seconds, and at max 3 such transactions can happen concurrently

c. Volume Model: This model maintains a frequency distribution of the number of logs of each pattern received for a fixed time internal. It is then used for detecting unusual spikes of certain patterns and reports them as alerts to the user.

FIG. 5 shows an exemplary Testing Phase module. The testing phase module has the following components:

Agent (301): The agent sends log data in a real-time streaming fashion to the log parser for tokenization. It controls the incoming log rate, and identifies the log Source.

Log Parser (302): The log parser components takes incoming streaming logs, and log-pattern model from the model manager as input. It preprocesses and creates a parsed output for each input log in a streaming fashion, and forwards it to the log sequence anomaly detector. All unparsed logs are reported as anomalies and presented to the user. Log parser is an example implementation of stateless anomaly detection algorithm.

Tokenized logs generated as output from the log parser are in the form of <key,value>pairs, where each key is either a word, number etc. The tokenized log also contains special keys for fields denoting either IP addresses or timestamps.

The streaming compute layer uses models learnt during training phase to process incoming log streams and generate anomalies. From an implementation point of view, these are all implementations of the instant Violation Checker abstractions (explained in Step 306), and can be classified into three different types of analytics.

Stateless Anomaly Detection Module (303): Stateless algorithms as the name suggests do not keep any state across multiple consecutive logs. This ensures that these classes of anomaly detection algorithms are completely parallelizable. Examples of stateless anomaly detection can be log tokenization and detecting logs which do not match any previous patterns. Clearly for log parsing and tokenization each log can be independently processed and does not depend on any previous log, making the whole process completely parallelizable. The content profile model in Step 202 is stateless. Later we describe an exemplary stateless anomaly detection algorithm in detail using reference architecture in FIG. 8.

Stateful Anomaly Detection Module (304): Stateful anomaly detection is the category of anomaly detection algorithms which require causal information to be kept, and an “in-memory” state as the anomaly is dependent on a number of logs and the order in which they happen. This means that the logs must be processed in their temporal order, and an “in-memory” state should be maintained which allows processing of a log given existing state calculated from all previous logs. An example of Stateful anomaly detection is looking at complex event processing; wherein we have a model depicting stateful automata's of logs. For instance database logs can have “start” events and “stop” events for each transaction, and there are expected time frames within which these events must finish up. Detecting such anomalies requires us to have knowledge of previous “start” events when processing “stop” events. The Sequence order model in Step 202 is stateful. Later we describe an exemplary stateful anomaly detection algorithm in detail using reference architecture in FIG. 8.

Time-Series Analyzer (305): Several anomaly detection techniques are based on time-series can be used. In the context of LogLens, time-series based anomaly detection either works directly on time-series data (CPU usage, memory usage etc.) or on time-series generated from text logs (frequency of logs of each pattern in a fixed time resolution). Time-series analyzer is a stateful algorithm. A Violation Checker interface provides several abstractions for this purpose:
1. Creating time-series from parsed logs: All parsed logs can be tokenized, parsed and associated with specific patterns based on the patterns learnt during the training phase. The time-series based anomaly detection can convert incoming parsed log streams into time-series with the following format <Timeslot>, <Pattern>, <Frequency>. Here the timeslot is the ending timestamp of each time bucket (for instance 10 second bucket, would have a timeslot at 10 sec, 20 sec, 30 sec etc.), and the frequency is the number of logs of the particular pattern received in that timeslot.
2. Alignment of time-series: Multi-Source time-series can be from multiple different non-synchronized Sources; this means that the time-series received in a single micro-batch may not be from the same timeslot in the Source. We do a best-effort alignment by waiting for the next timeslot from all Sources before proceeding with a combined time-series analysis.
Hence if a micro-batch has received the following timeslots:
Source 1:<Timeslot 1>, <Timeslot 2, >,<Timeslot 3>, <Timeslot 4>
Source 2:<Timeslot 1>, <Timeslot 2>, <Timeslot 3>
Aligned Output: <Timeslot 1<Source 1, Source 2>>, <Timeslot 2<Source 1, Source 2>>
Assuming a sorted input, the aligned Source will only have slots 1 and 2 as the system can only be sure that the system has received complete information regarding the first two slots.

Violation Checker (306): Violation Checker is an abstraction created for the streaming compute system and the model management system to provide ease of model update for each anomaly detection algorithm. The Violation Checker essentially allows for a “plug and play” framework, where new anomaly detection algorithms can simply implement the interface, and the LogLens framework will take care of all the common tasks through this abstraction. Some of the interfaces provided by the Violation Checker are:

Read Model: This gives an abstraction which integrates with the model manager to read the model from the model database, parse and save it in memory on the spark driver. These abstractions avoid having each analytical algorithm to develop an end-to-end connection with the model database.

Update Model: Once the model has been read using the “read model” abstraction, the update model abstraction is executed to update the model using the instant novel dynamic model update procedure into all distributed stream processing cluster

Delete Model: Similar to update model the delete model abstraction deletes relevant model from the distributed memory by invalidating it and removing it from all nodes in the cluster.

Execute Stream: The execute stream interface takes as input the log stream, and transforms the log stream according to the anomaly algorithm.

Execute Multiple Streams (time-series): This interface takes as input multiple log streams including time-series stream, and process multi-stream input using the anomaly algorithms and transform them into anomalies.

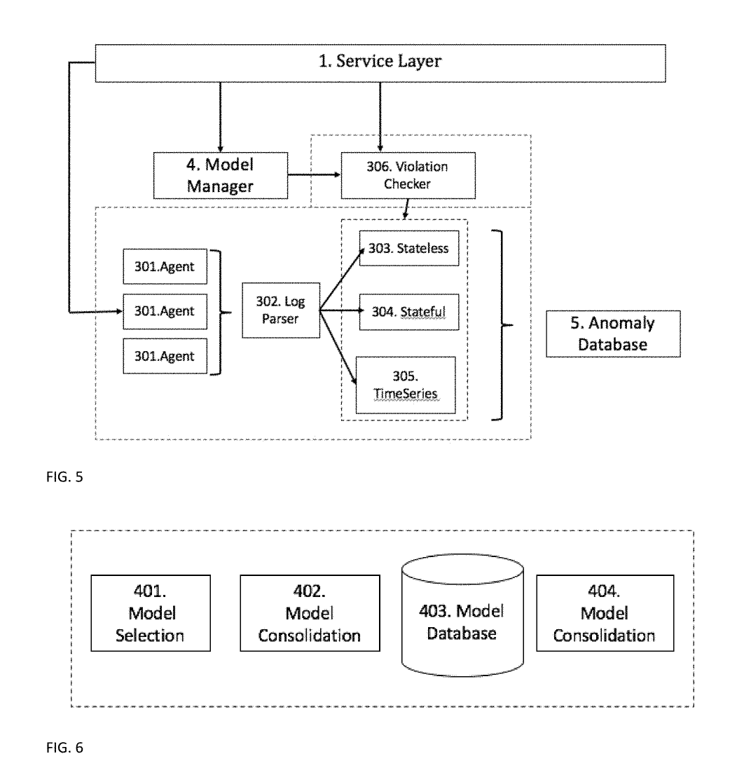

FIG. 6 is a block diagram of the Model Manager. The Model Manager 4 handles a model selection module (401), model consolidation modules (402 or 404), and a global model database (403). In the system, learning is a continuous process. System behaviors change and evolve over time, because of changing workloads, new configuration, settings or even patches applied to the software. This in essence means that the models learnt must also be frequently updated. Distributed learning and incremental learning are dependent on the model, and have been independently developed for each model. The global model database provides an interface to assist, and complement both these strategies to allow for a learning service, which can maintain its trained profiles in a database.

Turning now to FIG. 6, with respect to the Model Selection (401), the global model database component supports simple queries such as select model, create new model, delete model. Model selection can be based on queries such as timestamp, Sources, model category etc. Further there can be complex queries such as join, group, aggregate for grouping model categories, and aggregating models across different time ranges.

As to Model Consolidation (402), this sub-component deals with model-updates to support incremental or distributed learning processes. The update of the model themselves depends on the learning algorithm and the model profile. For instance the instant volume model can be easily updated using min/max and merging with them from the newer model. The Model Consolidation includes the following:
a. Create New Model: Update the model using the new model from the current training data. This enables an iterative process of improving the model with newer training logs. Alternatively, it also allows for distributed learning over very large training logs.
b. Save Model in the databases: The new model either needs to be updated or appended as a separate row in the model database.
c. Query Model from database: Query the relevant model from the database

The Model Database (403) has a hierarchical schema with each model kept as follows:
<TimeStamp, Time Range, Category, Source, Model>where:

1. Timestamp—Time at which model is generated

2. TimeRange—The time range of the training logs during which the model was created

3. Category—The category of model

4. Model—The model can be saved as a BLOB entry or a separate table

The Model Manager also handles Service API with a module 404 that supports the following Service API's:

a. Distributed Learning: Large training log sessions may sometimes require distributed learning to speed up the learning process. This requires novel model consolidation process, which can lock/unlock updates to the global model database, and allow for update queries to existing models.

b. Incremental Learning: Similar to distributed learning, models can be periodically updated with newer training data.

c. Query Models: At the time of testing querying model is a requirement this can be dependent on time-range, Source etc.

d. Model Database: A schema of a model management in a storage database.

The model manager also does several important functions for the instant compute framework:

1. Stores models generated by the training phase into a model database.

2. Fetches and updates the model in the instant testing compute system (spark streaming)

3. Deletes the model from testing compute system (spark streaming)

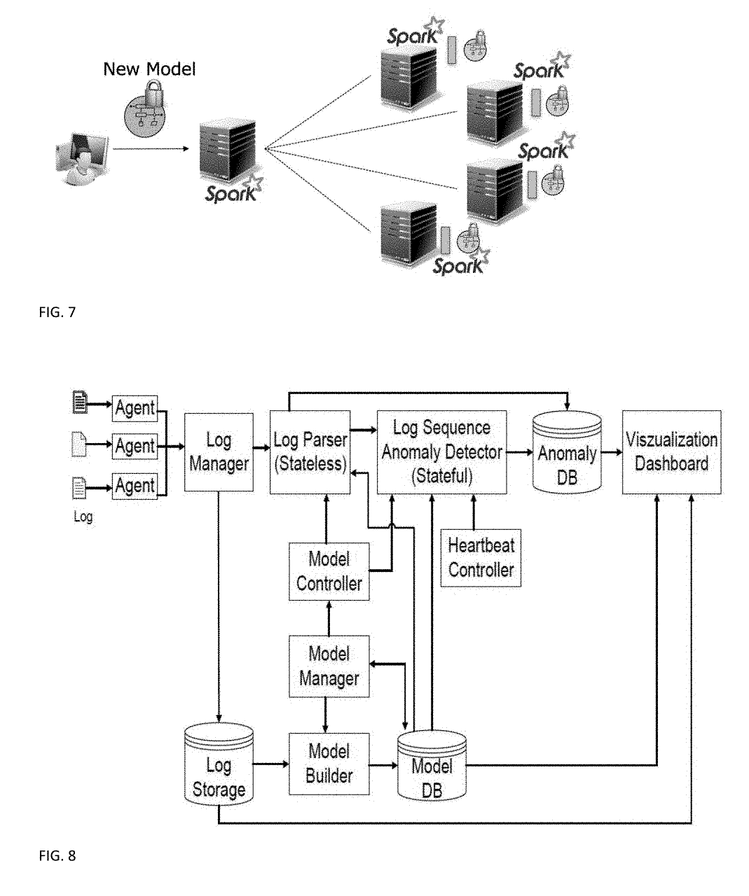

In particular operations (2) and (3) are updated using a unique dynamic model update mechanism (exemplified in FIG. 7.) for updating values in immutable distributed variables in streaming oriented systems. Once models are read from the database, an immutable object is created in the driver (in the context of spark streaming these variables are called broadcast variables). These immutable objects are then serialized and distributed to all spark execution nodes. Under normal circumstances, these objects are final and cannot be modified once the data streaming has been initialized.

The instant modification has been made for micro-batch oriented streaming architectures like spark which split incoming data into small data chunks called micro-batches before executing them. The dynamic model update queues all model update requests in an internal queue and updates them in between subsequent micro-batches. This is done by modifications in the scheduler, which checks the model queue for any new models before starting the execution of the data stream.

For new models a model entry is added to the model hash-map inside the driver memory, and this is fetched by each worker whenever it tries to look for the model. For model update processes, existing entries of the model object in the model hash-map in the driver memory is updated. When the workers are executed they detect the change and dynamically fetch the new model.

Thus, the framework of FIGS. 1-7 provides an end-to-end workflow for real-time heterogeneous log anomaly detection, which leverages unsupervised machine learning techniques for log parsing and tokenization to do anomaly detection. The system uniquely provides a service oriented log and model management framework with new log Source input and models. The system supports an extensible plug and play framework for common anomaly detection patterns such as stateless, stateful, and time-series anomaly detection. Dynamic model updates of distributed immutable in-memory models in streaming applications like spark streaming.

FIG. 8 shows in more detail the log analyzer architecture which has the following major components:

Agent collects logs from multiple log sources and sends them to log manager periodically. Agent is a daemon process and sends logs using Apache Kafka and its topic. it tags source information to logs. Agent operates in two ways: It sends real-time logs e.g., syslog or it can simulate real-time log from a large log file e.g., simulate a log stream from database.

Log Manager receives raw logs from agents, performs pre-processing and sends them to log parser. It controls incoming logs rate and identifies log source. It attaches this information into log and makes raw log into a semi-structured data. Finally, it stores log into log storage.

Log Storage stores logs. It uses a distributed storage with proper indexing while storing logs. Stored logs can be used for building models during log analysis. They can also be used future log replay for further analysis. It is connected to graphical user interface so that human can dig through logs and give their feedback.

Model Builder builds training model for each anomaly detector. It takes raw logs assuming that they represent normal behavior and uses unsupervised techniques to build models which are used for real-time anomaly detection. As log stream may evolve over time, models need to be updated periodically. Therefore, model builder collects logs from log store and build models accordingly and stores it to model database.

Model DB stores models. It uses a distributed storage with proper indexing while storing logs. All the anomaly detectors read models directly from model database. Furthermore, they are directly attached to graphical user interface, so that user can validated the model and update them if required.

Model Manager reads models from model DB and notifies model controller for model update. LogLens supports both automatic and human interaction inside model manager. For example, it has an automatic configuration which tells model builder to update model at the end of each day. On the other way, human expert can directly modify the model and updates model in model database using model manager.

Model Controller gets notifications from model manager and sends model control instruction to anomaly detectors. Model can be inserted, updated or deleted. Each of them needs separate instructions. Moreover, for an updated model, from where the anomaly detector will lookup/read the model is clearly defined in model instructions. Anomaly detectors read the control instructions and update model accordingly.

Log Parser parses incoming streaming logs from log manager. It reads log and finds its pattern. It identifies logs as anomaly when it cannot parse them and stores them to anomaly database. Log parser uses a model that is built in unsupervised. Model controller notifies it to update model when it requires and it reads model from model db. As log parser parses one log at a time, it is stateless.

Log Sequence Anomaly Detector captures anomalous log sequence of an event or transaction in real-time. It uses an automaton to identify abnormal log sequences. As it requires transaction, it is stateful. Its automata are built in unsupervised and it reads model from model DB when model controller notifies. It stores all anomalies to anomaly database.

Heartbeat Controller controls identifies open transactions in log sequence anomaly detector. Each transaction has begin, end, and intermediate states. Using heartbeat controller, anomaly detector easily detects open state in an event log sequence and report them as anomalies.

Anomaly DB stores all kind of anomalies for human validation. It uses a distributed storage with proper indexing while storing logs. Moreover, each anomaly has a type, severity, reason, location in logs, etc. All of them are stored in an anomaly database which is connected to a graphical user interface for user feedback.

Visualization Dashboard provides a graphical user interface and dashboard to end user. It gets data from log storage and anomaly database. Each dashboard contains particular anomaly type, reason, details information, time of occurrence, etc. User will get them in real-time or in a batch report and takes necessary steps if required. Human can easily validate anomaly and give their feedback.

Model Learning/Training Workflow is described next. LogLens requires model for each of its anomaly detector. These models are built from normal logs. Machine learning techniques have been used to build the model. Log manager collects log from agents and sends logs to log storage periodically. Log storage has the log with time stamp. Model Manager instructs model builder to build model for an anomaly detector. Inside model manager, we can set the LogLens configuration so that it can instruct model builder to build model for an anomaly detector at certain time interval, e.g., at the end of the day. We can also instruct model builder manually to build model when it requires. As soon as model builder gets instruction from model manager, it collects its required logs from log storage. Model manager tells model builder about time period for logs to build the model. Different anomaly detectors use different techniques to build the model. For example, log parser used unsupervised clustering technique to build its model, while event based log sequence anomaly detector uses unsupervised event id discovery to generate its model. After building model, model builder stores model into model database. Human expert validates the model and changes them if requires. The updated models are stored in model database via model manager. After building model, model manager notifies model controller and model controller informs an anomaly detector to update model. Anomaly detector reads model directly from model database.

Anomaly Detection Workflow is described next. Real-time anomaly detection is the key part of LogLens. Agent continuously sends logs. Log parser collects these logs via log manager. It parses these logs using its model. Its model contains a set of rules which discover log patterns. Logs are reported to anomaly with unknown log pattern when it cannot parse them properly. After that, all the parsed logs go to log sequence anomaly detector. It has automata containing a set of rules to find an anomalous sequence for an event transaction. Its model contains the automata with rules. Logs belonging to a particular sequence are reported as anomaly if they do not follow the rules in automata. All of the reported anomalies are stored in anomaly database for human validation. Capturing anomalous sequence from incoming log is a stateful operation as it requires storing transaction. On the other hand, parsing logs is a stateless operation. So, LogLens covers both stateful and stateless anomaly detection.

Model Update Workflow is described next. Behavior of logs may change over time. Sometimes new log source may come. These require model update dynamically. LogLens performs model update through its model manager, model controller, and model builder. Model update can be instructed automatically of manually from model manager to model builder. Model builder builds new model and stores it to model database. Model manger then notifies model controller. Model controller sends control instruction to anomaly detector to update model. Finally anomaly detector read updated model from model database.

Real-time Stateful Workflow is described next. Real-time stateful anomaly detection requires controlling open state. For example, in log sequence based anomaly detection, some states may be opened for a long time because they have not reached the end state of the transaction. LogLens has a module Heartbeat (HB) controller to control these open states. Basically, it sends a HB message and when anomaly detector finds this message, it scans through all the open state and report missing end event anomaly if they are opened for a long time. Finally, these anomalies are stored to anomaly database.

Next, the real-time anomaly detection, and dynamic model update and heartbeat control are detailed. As per FIG. 1, LogLens provides both stateful and stateless anomaly detection for log analysis. Log parser is stateless anomaly detection as it parses log only and does not require preserving log flow information. On the other hand, log sequence anomaly detector is stateful as it keeps track of log transactions. In the next subsections, we describe them in details.

Log Parser parses logs and extracts patterns from heterogeneous logs without any prior information. It reports anomaly while it fails to extract pattern from log. Log parser requires training and testing for extracting patterns. The system can either use user provided log format as training model or generate log format automatically. LogLens uses following steps to generate a model for log parsing:
1. Clustering. It takes the input heterogeneous logs and tokenizes them to generate semantically meaningful tokens from them. After that, it applies a log hierarchical clustering algorithm to generate a log cluster hierarchy.
2. Log Alignment. After clustering, it aligns logs within each cluster that on the lowest level in the log cluster hierarchy. The log alignment is designed to preserve the unknown layouts of heterogeneous logs so as to help log pattern recognition.
3. Pattern Discovery. Once the logs are aligned, log motif discovery is conducted so as to find the most representative layouts and log fields. It recognizes log format patterns in a form of discovered regular expressions. It assigns a filed ID for each variable field in a recognized log format pattern. The field ID consists of two parts: the ID of the log format pattern that this field belongs to, and the sequence number of this field compared to other fields in the same log format pattern. The log format pattern IDs can be assigned with the integer number 1,2,3, . . . n for a log pattern set of size N, and the field sequence order can be assigned with the integer number 1,2,3, . . . k for a log format with k variable fields.

Log parser uses patterns discovered during learning stage for anomaly detection. If a log message does not match with any patterns in the model, it is reported as an anomaly. If a match is found, it parses a log into various fields based on matched pattern format. We implement Log parser using a simple MapReduce logic in Spark. Pattern models are read from the model storage and broadcasted to all workers. In workers, Map function does the parsing using discovered patterns and tags all logs as matched or unmatched. Reduce function simply collects all logs. After that, we filter unmatched logs and send them to the anomaly storage, while matched logs are sent to the log sequence anomaly detector for identifying anomalous log sequence.

LogLens provides stateful log analysis using event log sequence based anomaly detector which gets matched logs from log parser as input. It groups logs belonging to an event as a sequence or transaction and detects anomaly if they do not follow certain rules. For this, it keeps track log flow information into memory or state. It requires training and testing for its anomaly detection.

LogLens uses an unsupervised technique to discover event identifier (ID) from logs and builds automata using them. Each automaton contains a set of rules which are used to validate anomalous log sequences. Event IDs in streams of system event logs are the type of content which may appear the same in multiple log instances, in many unique values through the history, at stable locations in the same log event type, or in stable structure across multiple log event types. They allow deterministic association of logs representing system/service behaviors such as Database transactions, Operational requests, Work job scheduling events, and so on.

Event identifier discovery technique is discussed next. First a reverse index of training logs is constructed by LogLens. It generates a reverse index table where indexing key is event ID content and value is a list of log patterns that have this key. It generates a hash table. Algorithm 1 describes the procedure based on the log formats

Algorithm 1 Reverse index of training logs

```
  1: procedure REVERSEINDEX(Training logs L)
  2: HashMap H < K,V >
  3: for i ← 1 to size(L) do
  4: Pₓ ← FindPattern(Lᵢ)
  5: for j ← 1 to Lᵢ.totalFields( ) do
  6: v ← Lᵢ.getFieldValue(Fⱼ)
  7: H(v).insert((PₓFⱼ,Lᵢ))
  8: end for
  9: end for
10: end procedure
```

LogLens takes training logs as input and generates a hash table as output. It initializes a hash table H where key is an index key, and value is an object set. For each training log Lᵢ, it repeats in finding the format pattern Pattern-x matching Lᵢ (e.g., through a regular expression testing) among the recognized log formats and assigning the value v for each variable field PₓF, in Pattern-x for the matched part in Lᵢ; insert into H under the key v as H(v).insert((PₓFⱼ, Lᵢ)).

Log parser uses model to extract pattern from heterogeneous log. Any log message does not match to any patterns in the model is reported to anomaly. Matched logs are sent to log sequence anomaly detector for identifying anomalous log sequence.

Log parser extracts log patterns in real-time. It is built using Apache Spark. It has map reduce based efficient pattern discovery technique.

ID field discovery is done on pattern field pairs. This produces event ID set that covers all logs in training. It uses associate rule mining technique to produce event ID field set. Algorithm 2 describes it. It takes log pattern field sets grouped under hash table keys as input and generates an event ID field set as output. It initializes a hash table T where key is a composite index key, and value is an object set. For each entry under the key k in the hash table H, it repeats by creating a composite key ck which includes all the pattern fields in H(k), and insert into T under the key ck all the log numbers Lᵢ in H(k). After that, it initializes another hash table F where key is a composite index key, and value is an integer initialized as 0. For each entry under the key k in the hash table T, it repeats by assigning the integer i as the total number of unique logs in T (k) and for each unique 2-fields pair P=(PᵢFₓ, PⱼF_{y}) derived from the pattern fields contained in the composite key k, it updates T so that F (p)=F (p)+i. Finally, for each entry under the key k=(PᵢFₓ, PⱼF_{y}) in the hash table F, it repeats by inserting k=(PᵢFₓ, PⱼF_{y}) into pattern ID field set container IDs if F (k) equals to the number of the training logs matching pattern Pᵢ or Pⱼ.

Algorithm 2 ID field discovery

```
  1: procedure ASSOCIATERULEMINING(HashMap H <
    K,V >)
  2: HashMap T < K,V >
  3: for each < k,v > ∈ H do
  4: if v.size( ) > 1 then
  5: ck ← v.get.PatternFields( )
  6: T(ck) ← v.getUniqueLogIndices( )
  7: end if
  8: end for
  9: HashMap F < K,V >
10: for each < k,v > ∈ T do
11: i ← count(v)
12: for each 2 - fields pair P = (PᵢFₓ,PⱼF_{y}) ∈ k
    do
13: F(P) ← F(P) + 1
14: end for
15: end for
16: IDs ← { }
17: for each < k = (PᵢFₓ,PⱼF_{y}), v > ∈ F do
18: If v = count(P₄) or v = count(Pⱼ) then
19: IDs.insert((PᵢFₓ,PⱼF_{y}))
20: end if
21: end for
22: end procedure
```

Event automata modeling corresponds to the processes of profiling and summarizing event behaviors on log sequence sets grouped by ID content in automata.

1. Event automata modelling procedure. For the training logs, it builds the automata model based on the ID field knowledge. Algorithm 3 shows the details of event automata modelling procedure. It takes training logs and event ID field set as input and generates automata as output. Initially it groups on ID content. It initializes a hash table G where key is a composite index key, and value is an ordered object list. For each log Lᵢ in the training logs, it finds the log pattern with associate fields and creating a composite key k which consists of the log content matching those ID fields. After that it inserts into the hash table G as G(k).insert((TimeStamp(Lᵢ), IDs(Pⱼ)), where the ordered object list is sorted by the time stamps and IDs(Pⱼ) is the ID fields of the log format Pⱼ.

Algorithm 3 Event automata modeling

```
  1: procedure BUILDAUTOMATA(Training logs L, ID Fields ID.
  2: HashMap G < K,V >
  3: for i ← 1 to size(L) do
  4: Pⱼ ← FindPattern(Lᵢ)
  5: Fₓ ← IDs(Pⱼ)
  6: k ← Lᵢ[Fₓ]
  7: t ← Time_Stamp(Lᵢ)
  8: G(k).insert((t,IDs(Pⱼ)))
  9: end for
10: Automata Model M = { }
11: for each < k,v > ∈ G do
12: IDs(P_{b}) ← v.getBegin( )
13: IDs(Pₑ) ← v.getEnd( )
14: IDs(Pᵢ) ← v.getIntermediates( )
15: if (IDS(P_{b},IDs(Pₑ) ∈ M then
16: UpdateM in MaxDuration(t_{b}, tₑ)
17: UpdateConcurrency(IDs[Pᵢ])
18: else
19: M.insert(IDs(P_{b}),IDs(Pₑ),IDs[Pᵢ])
20: SetDuration(t_{b}, tₑ)
21: SetConcurrency(IDs[Pᵢ])
22: end if
23: end for
24: end procedure
```

2. Event automata generation based on log groups. After that it initializes an automaton mode set M. For each entry under the key k in the hash table G, it finds begin, end, and intermediate the ordered ID field sets in G(k). Let IDs(P_{b}) be the earliest based on the time order, IDs(Pₑ) be the latest based on the time order, and IDs[Pi be the rest or intermediate of the ID field sets. If the model set M has no event automata with its begin event pattern matching IDs(P_{b}) and end event pattern matching IDs(Pₑ), create a new event automata model in M, with its begin event type set as IDs(P_{b}), and its end event pattern set as IDs(Pₑ), the min, max duration between its begin event type and its end event pattern set as the difference between the time stamp of IDs(P_{b}) and IDs(Pₑ), and adding the intermediate event types with IDs(Pᵢ), and set all the min, max concurrency of the intermediate event types based on their frequency in IDs(Pᵢ). Otherwise, there is an already event automata model in the model set M with its begin event pattern matching IDs(P_{b}) and end event pattern matching IDs(Pₑ) and update that event automata model on the min, max duration between its begin event type and its end event pat tern based on the difference between the time stamp of IDs(P_{b}) and IDs(Pₑ), and also update the intermediate event types and their min, max concurrency based on IDs(Pᵢ) accordingly.

Algorithm 4 Anomaly detection

```
  1: procedure CHECKANOMALY(Logs L, ID Fields IDs, Automata M)
  2: HashMap E < K,V >
  3: for i ← 1 to size(L) do
  4: Pⱼ ← FindPattern(Lᵢ)
  5: Fₓ ← IDs(Pⱼ)
  6: anomaly ← true
  7: if Pⱼ ∈ M.models( ) then
  8: k ← Lᵢ[Fₓ]
  9: i ← Time_Stamp(Lᵢ)
10: if Ek = Empty( ) then
11: for each A ∈ M.models( ) do
12: if IDs(Pⱼ) = A.getBegin( ) then
13: E(k).insert(A,t)
14: anomaly ← false
15: end if
16: end for
17: else
18: A = E(k)
19: if IDs(Pⱼ) = A.getEnd( ) then
20: anomaly ← CheckDuration(A,t)
21: anomaly ← CheckConcurrency(A)
22: else
23: A.Concurrency(IDs(Pⱼ))
24: anomaly ← CheckConcurrency(A)
25: end if
26: end if
27: end if
28: end for
29: return anomaly
30: end procedure
```

Event sequence anomaly detection takes heterogeneous logs collected from the same system for event sequence behavior testing. The process uses the event automata for profiling and detecting abnormal behaviors of log sequence sets grouped by ID content, which is defined by the event ID field content.

Algorithm 4 shows the details of the event sequence anomaly detection procedure for the testing procedure. It takes testing log, event ID field set, and automata as input and report anomaly as output. It initializes a hash table for active event automata instances. The hash table E uses ID content as the key, and active automata instances as the value. Initially it is empty. Here, logs are grouped based on ID content. For each arriving log L, from the testing log stream, if its matching format pattern does not contain any ID field in any automata model, it skips. Otherwise, it finds event automata matching on log sequence groups. For the ID content k and ID fields in the log Lᵢ, if there is no active automata instance in the hash table E under the key k, and Lᵢ's ID fields do not match the beginning event type of any automata, it reports an alert message for log Lᵢ about missing other expected events based on the automata model it matches, goes back for the next log. On the other hand, if there is no active automata instance in the hash table E under the key k, and Lᵢ's ID fields match the begin event type of any automata, it inserts into the hash table E under the key k a new active automata instance and goes back for the next log. When there is an active automata instance A in the hash table E under the key k, it first checks if Lᵢ's ID fields match the end event type of A, check A's model parameter violation on the (min, max) duration and (min, max) intermediate event concurrency based on the past logs with the same ID content k and the log L. If there is any violation, it reports an alert message for the automata instance A about those logs causing the model violation and removes automata instance A from the hash table E and goes for the next log. Otherwise, If Lᵢ's ID fields does not match the end event type of A, update A's model parameters on the related (min, max) intermediate events concurrency based on the past logs with the same ID content k and the log Lᵢ. If there is any violation, it reports an alert message for log Lᵢ causing the model violation and goes back for the next log.

Tables 1 show all the anomaly types. Automata in the training model have all the rules related to normal event log sequences. Any violation will generate those anomalies.

TABLE 1
Type of anomalies

| Type | Anomaly |
|---|---|
| 1 | Missing begin event |
| 2 | Missing end event |
| 3 | Missing intermediate events |
| 4 | Min/Max occurrence violation of intermediate events |
| 5 | Min/Max time duration violation in between begin and end event |

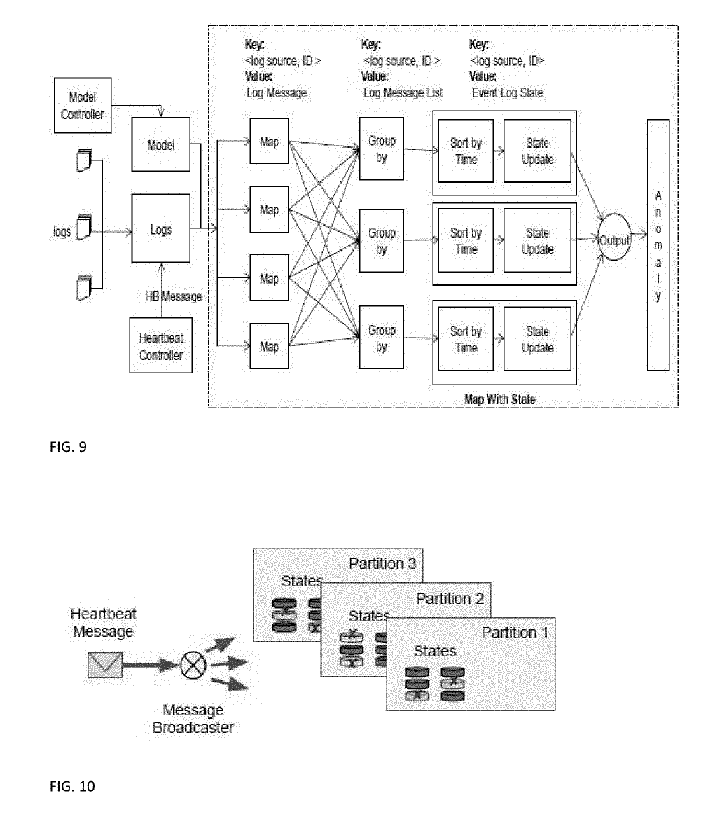

Real-time anomaly detection uses Apache Spark in one embodiment. LogLens uses Apache Spark to detect anomalous log sequence in real-time. The MapWithState API in Spark Streaming is an ideal solution for sequence analysis as it stores temporal information in state/memory. FIG. 9 shows distributed implementation of sequence based anomaly detection using Spark Streaming. At first, LogLens builds model for each log source. It has a model controller which controls model update. The models are built in offline from training logs. So, it uploads model into Spark's shared broadcast variables. The broadcast variable stores models as <LOG SOURCE, MODEL >mapping. When logs are coming as stream, it collects them. After that, it extracts LOG SOURCE and ID field content as ID from each log. It maps them as <KEY, VALUE >pair, where KEY is a composite key having <LOG SOURCE, ID > and VALUE is log message. It groups them by KEY=<LOG SOURCE, ID and sends them to MapWithState operation, which is basically a map operation with embedded state. Inside MapWithState, it will get all the log messages having same key. It sorts them according to log's time stamp. It loads it current state. If it does not have any current state, it creates a new state. Each state contains active automata. For each log messages from sorted list, it checks any sequence violation. It reports anomaly if it identifies any abnormal/unusual sequence, otherwise saves current state. Sometimes we see many open states with missing end state for a long time. LogLens introduces a Heartbeat manager to send heartbeat (HB) message (i.e., dummy log) periodically and identifies those state with reporting anomaly if they remains open for a long time. FIG. 10 shows HB message propagation procedure in LogLens.

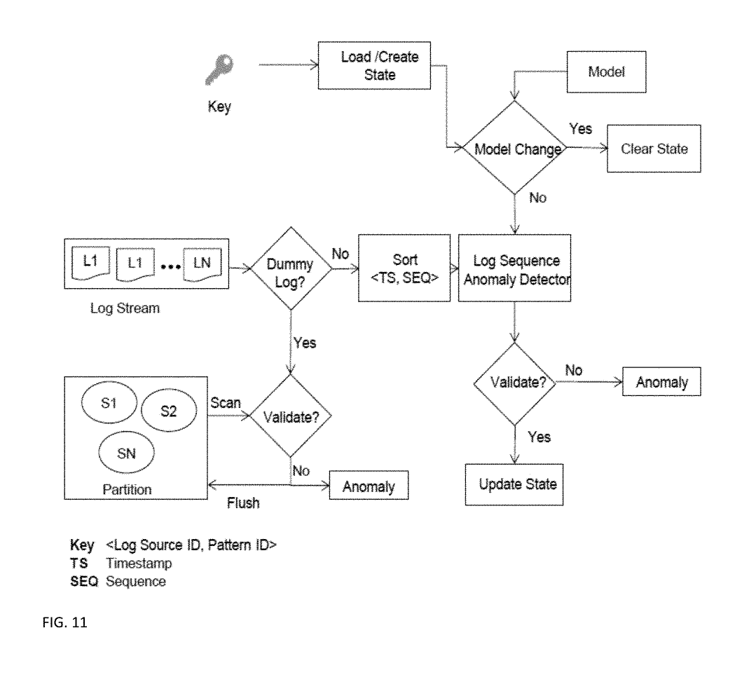

FIG. 11 shows internal operation in MapWithState. As LogLens provides model update and Heartbeat controller, it has some extra overheads. Each worker performs MapW ithState operation. So, when a model is uploaded for a source using a broadcast variable, it should be checked inside worker. Each model has a unique hash code. If the current state's model and broadcast model have different hash codes, then it discards all operation and clears the state. Otherwise, it scans log messages. If it finds any HeartBeat message, it scans all the active states in its current partition. It checks time duration of each states begin time with dummy log's arrival time. If the duration cross a threshold (opened for a long time without end event), it reports missing end event anomaly for that state's active automata and clears them from memory. If a usual log message comes, it sorts all the log messages and performs violation checking for incoming logs. If it finds unusual sequences, it reports with anomaly. Finally it updates states. If it reaches end of active automata, it clears its state.

By way of example, a block diagram of a computer or controller or analyzer to support the invention is discussed next. The computer or controller preferably includes a processor, random access memory (RAM), a program memory (preferably a writable read-only memory (ROM) such as a flash ROM) and an input/output (I/O) controller coupled by a CPU bus. The computer may optionally include a hard drive controller which is coupled to a hard disk and CPU bus. Hard disk may be used for storing application programs, such as the present invention, and data. Alternatively, application programs may be stored in RAM or ROM. I/O controller is coupled by means of an I/O bus to an I/O interface. I/O interface receives and transmits data in analog or digital form over communication links such as a serial link, local area network, wireless link, and parallel link. Optionally, a display, a keyboard and a pointing device (mouse) may also be connected to I/O bus. Alternatively, separate connections (separate buses) may be used for I/O interface, display, keyboard and pointing device. Programmable processing system may be preprogrammed or it may be programmed (and reprogrammed) by downloading a program from another source (e.g., a floppy disk, CD-ROM, or another computer).

Each computer program is tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention.

What is claimed is:

1. A method for processing a stream of logged data, comprising:
creating one or more models from a set of training logs during a training phase;
receiving testing data in real-time and generating anomalies using the models created during the training phase;
updating the one or more models during real-time processing of a live stream of logs; and
detecting a log anomaly from the live stream of logs.

2. The method of claim 1, comprising performing real-time heterogeneous log anomaly detection.

3. The method of claim 1, comprising using unsupervised machine learning for log parsing and tokenization for anomaly detection

4. The method of claim 1, comprising dynamically updating distributed immutable in-memory models in a streaming application.

5. The method of claim 1, wherein the streaming application is spark streaming.

6. The method of claim 1, wherein the receiving of testing data comprises spark streaming the logs.

7. The method of claim 1, comprising extensible plug and play framework for common anomaly detection patterns such as stateless, stateful, and time-series anomaly detection.

8. The method of claim 1, comprising highlighting potential anomalies in real-time.

9. The method of claim 1, comprising detecting anomaly detection patterns including stateless, stateful, and time-series anomaly detection.

10. The method of claim 1, comprising automating log mining and management processes for administrators.

11. A system for processing a stream of logged data, comprising:
a database to store one or more models created from a set of training logs during a training phase;
a processor with code for:
receiving testing data in real-time and generating anomalies using the models created during the training phase;
updating the one or more models during real-time processing of a live stream of logs; and
detecting a log anomaly from the live stream of logs.

12. The system of claim 11, comprising code for performing real-time heterogeneous log anomaly detection.

13. The system of claim 11, comprising code for using unsupervised machine learning for log parsing and tokenization for anomaly detection

14. The system of claim 11, comprising code for dynamically updating distributed immutable in-memory models in a streaming application.

15. The system of claim 11, wherein the streaming application is spark streaming.

16. The system of claim 11, wherein the receiving of testing data comprises spark streaming the logs.

17. The system of claim 11, comprising an extensible plug and play framework for common anomaly detection patterns such as stateless, stateful, and time-series anomaly detection.

18. The system of claim 11, comprising code for highlighting potential anomalies in real-time.

19. The system of claim 11, comprising code for detecting anomaly detection patterns including stateless, stateful, and time-series anomaly detection.

20. The method of claim 1, wherein the logs are received an Internet of Things (IOT) device, a software system, point of sales system.
